(19) United States
(12) Patent Application Publication
(10) Pub. No.: US 2025/0159472 A1
(43) Pub. Date: May 15, 2025

(54) HANDLING ADDRESS COLLISIONS WITHIN AN EXTENDED SERVICE SET

(71) Applicant: Cisco Technology, Inc., San Jose, CA (US)

(72) Inventors: Domenico FICARA, Essertines-Sur-Yverdon (CH); Javier I. CONTRERAS ALBESA, Sant Cugat del Valles (ES); Jerome HENRY, Pittsboro, NC (US); Stephen M. ORR, Wallkill, NY (US)

(21) Appl. No.: 18/936,567

(22) Filed: Nov. 4, 2024

Related U.S. Application Data
(63) Continuation of application No. 18/907,284, filed on Oct. 4, 2024.
(60) Provisional application No. 63/597,817, filed on Nov. 10, 2023.

(51) Int. Cl. H04W 8/26; H04L 61/5007; H04L 61/5046

(52) U.S. Cl. CPC H04W 8/26; H04L 61/5007; H04L 61/5046

(57) ABSTRACT

The present disclosure provides techniques for handling MAC address collision within an ESS comprising at least one wireless station and at least one access point (AP). An AP receives a first IRM address during execution of a handshake protocol between the AP and a wireless station. The AP determines that the first IRM address is allocated for use by another wireless station and then transmits a message to the wireless station. The AP receives a first wireless action frame transmitted by the wireless station after execution of the handshake protocol, where the wireless action frame includes a second IRM address selected by the wireless station. The AP establishes a wireless connection with the wireless station in a subsequent association with the wireless station using the second IRM.

### CROSS-REFERENCE TO RELATED APPLICATIONS

This application is a continuation of co-pending U.S. patent application Ser. No. 18/907,284 filed Oct. 4, 2024, which claims benefit of U.S. provisional patent application Ser. No. 63/597,817 filed Nov. 10, 2023. The aforementioned related patent application is herein incorporated by reference in its entirety.

### TECHNICAL FIELD

Embodiments presented in this disclosure generally relate to wireless communication. More specifically, embodiments disclosed herein relate to handling media access control (MAC) address collisions within an extended service set (ESS).

### BACKGROUND

In IEEE 802.11 wireless networks, access points (APs) use a station's (STA) MAC address to manage network access and facilitate communication. With each STA having a unique MAC address within a network, data packets to different STAs may be properly routed, avoiding conflicts and maintaining smooth operation. To enhance privacy and security, there have been several proposed solutions for MAC address rotation and randomization, particularly in the IEEE 802.11bh standard. One such solution is Identifiable Random MAC (IRM), which allows STAs to freely decide their next MAC address to use at the next association and simply report it to the connected AP. However, this method introduces a risk of MAC address collisions. Since each STA selects a new MAC address without coordination, there is no mechanism to prevent a client from choosing a MAC address that is already in use by (or stored for use by) another client within the same ESS.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example ESS supporting MAC address coordination, according to some embodiments of the present disclosure.

FIG. 2 depicts an example sequence of messages exchanged between a STA, AP, and WLC to address MAC address collisions, according to some embodiments of the present disclosure.

FIG. 3 depicts an example method for an AP verifying the status of a received MAC address and coordinating with a STA to avoid collision, according to some embodiments of the present disclosure.

FIG. 4 depicts an example method for a STA proposing a MAC address and submitting the address to its connected AP for verification, according to some embodiments of the present disclosure.

FIG. 5 is a flow diagram depicting an example method for MAC address coordination, according to some embodiments of the present disclosure.

FIG. 6 depicts an example network device supporting MAC address coordination, according to some embodiments of the present disclosure.

FIG. 7 depicts an example client device supporting MAC address coordination, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including selecting, by a wireless station, a first Identifiable Random Media Access Control (MAC) (IRM) address, sending, by the wireless station, the IRM address in an IRM information element during execution of a handshake protocol between the wireless station and the AP, receiving, by the wireless station, a message from the AP indicating whether the selected IRM address is allocated for use by another wireless station, responsive to the message from the AP indicating that the selected IRM address is allocated for use by another wireless station, selecting, by the wireless station, a second IRM address different from the first IRM address, and transmitting, by the wireless station, a first wireless action frame to the AP after execution of the handshake protocol, where the wireless action frame includes the second IRM address, and using, by the wireless station, the second IRM address in a subsequent association with the wireless AP or any other AP in a same extended service set (ESS) of the wireless AP.

Other embodiments in this disclosure provide a non-transitory computer-readable storage medium having stored therein instructions which, when executed by a processor, cause the processor to perform operations, the operations comprising in accordance with one or more of the above methods, as well as a wireless station comprising at least one memory element for storing data, and at least one processor for executing instructions associated with the data, where executing the instructions causes the wireless station to perform operations in accordance with one or more of the above methods.

### Example Embodiments

A collision, such as when two devices in the same ESS use the same MAC address, becomes more likely in networks with a large number of clients because IRM addresses are randomly generated by the clients and reported to the AP without prior coordination. When such collision occurs, communication conflicts may arise because the AP cannot effectively distinguish between the devices sharing the same MAC address. Data packets to one device may be misrouted to another one, or even lost, leading to degraded network performance and unreliable connections. Additionally, the MAC address collision further complicates network management, as both the APs and the central network management system cannot accurately track or manage their associated devices.

To address this issue, the present disclosure introduces techniques for coordinating the MAC addresses to ensure that each address used within the network is unique. In one embodiment, the STA may send to its associated AP the next MAC address it intends to use during the 4-way handshake process, such as in one of the handshake messages sent from the STA to the AP. After receiving the proposed MAC address, the AP may communicate with a wireless LAN controller (WLC) to check an ESS-wide database, and verify whether the proposed MAC address is already in use or stored for use by another STA. If the address is free, the AP may allocate it to the STA, and update the database via the WLC to reflect the new allocation. In some embodiments, the WLC may synchronize the database with the new allocation across all APs within the ESS. If the address is already in use by another STA, the AP may notify the STA of the collision and the STA may select a different address and resubmit send it in an action frame to the AP after completion of the 4-way handshake. The disclosed process provides that each STA's proposed MAC address is verified as unique within the ESS, therefore avoiding potential communication conflicts and simplifying network management.

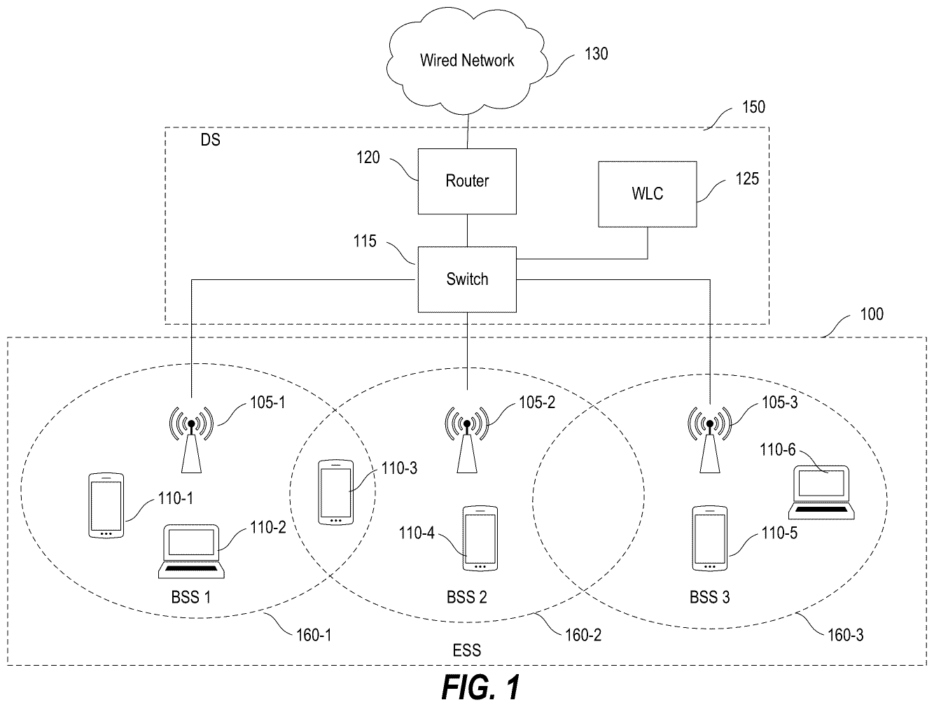

FIG. 1 depicts an example ESS 100 supporting MAC address coordination, according to some embodiments of the present disclosure.

As depicted, the example ESS 100 includes three basic service sets (BSSs): BSS 1 (160-1), BSS 2 (160-2), and BSS 3 (160-3). Each BSS 160 includes an AP 105 and its associated STAs 110. For example, BSS1 includes the AP 105-1 and STA 110-1, STA 110-2, and STA 110-3. BSS 2 includes the AP 105-2 and STA 110-4, and BSS 3 includes the AP 105-3, STA 110-5 and STA 110-6. The three BSSs 160 are connected together by a distributed system (DS) 150, which includes the switch 115, router 120, and WLC 125. Through the DS 150, each STA 110 is connected to the wired network 130, and can receive data from the network and/or transmit data to the network. In some embodiments, the wired network 130 may be either a local network (LAN) (e.g., an enterprise network) or a wide area network (WAN) (e.g., Internet).

The ESS 100 works as a single network with a common service set identifier (SSID) that STAs 110 recognize and connect to. Each BSS 160 operates on a specific channel and is identified by a unique basic service set identifier (BSSID), which is typically the MAC address of the AP 105.

In some embodiments, the example ESS architecture 100 may be applied in large buildings, campuses, or enterprise environments. When users are moving within these environments (e.g., ESS 100), their devices (e.g., STAs 110) may roam across different BSSs 160 within the same ESS 100 while maintaining their network connection. For example, STA 110-3, which is located within the overlapping area of BSS 1 (160-1) and BSS 2 (160-2), may disassociate from AP 105-1 and reassociate with AP 105-2 as it moves closer to AP 105-2. The roaming process across BSSs 160 may provide continuous connectivity and an uninterrupted user experience.

Each STA 110 may generate a MAC address, such as following IRM protocols, to uniquely identify itself within the network. The STA's MAC address may be used for several purposes, such as being included within the authentication request to initiate communication or within the association request to establish a connection with an AP 105. To ensure that the MAC address is unique within the current ESS 100, in some embodiments, after association with an AP (e.g., 105-1), the STA (e.g., 110-1) may send the next MAC address it intends to use to the AP for verification. In some embodiments, the next MAC address may refer to the address that the STA intends to use in the next association process. For example, when the STA roams from one BSS (e.g., BSS 1 (160-1)) to another (e.g., BSS 2 (160-2)), it needs to disassociate from the current AP (e.g., 105-1) and reassociate with a new AP (e.g., 105-2). The next MAC address may be included within the authentication request and association request to the new AP.

In some embodiments, the proposed next MAC address may be encapsulated within an IRM-Information Element (IRM-IE), and sent in one of the handshake messages sent by the STA to the AP during the 4-way handshake process. As used herein, the IRM-IE may refer to a data structure designed specifically for MAC address verification. The IRM-IE may include one or more fields, such as the proposed next IRM address, the current IRM address, the verification status (e.g., collision or recognized), and a timestamp or nonce to prevent replay attacks. In some embodiments, the IRM-IE may include an additional field that specifies the validity time (or lease time) of the proposed next MAC address. The field may contain a timestamp indicating the exact expiry time, or a duration (e.g., in seconds) that defines how long the next MAC address is reserved for use after being assigned. When the validity time passes, the MAC address may be released back into the pool of available addresses and potentially reassigned to another STA.

Upon receiving the proposed MAC address, the AP (e.g., 105-1) may share the address with the WLC 125. In some embodiments, the WLC 125 may connect to an ESS-wide database, which includes information on all active MAC addresses within the ESS 100. By checking the ESS-wide database, the WLC 125 may determine whether the proposed MAC address is already in use, and communicate the results back to the AP (e.g., 105-1). In some embodiments, protocols like Inter-Access Point Protocol (IAPP)/IEEE 802.1f may be used to facilitate communication between the AP 105 and WLC 125.

If the address is free, the AP (e.g., 105-1) may notify the STA (e.g., 110-1) of the allocation, and update the ESS-wide database (via the WLC 125) to reflect the new assignment. In some embodiments, a status of “recognized” may be encapsulated within an IRM-IE and sent to the STA in a handshake message. If the address is in use, the AP may send a message to the STA notifying the STA of the collision, such as by encapsulating the status of “collision” within the IRM-IE or other action frame and sending it to the STA. After the 4-way handshake is completed, the STA (e.g., 110-1) may send a new proposed MAC address to the AP (e.g., 105-1) for verification. In some embodiments, the new proposed MAC address may be included in an IRM-IE, and sent in an action frame to the AP. The verification process may be repeated until a unique MAC address is allocated to the STA. Each STA 110 within the current ESS 100 may use this approach to determine a unique MAC address for the next association use. By doing so, MAC address collisions among STAs can be effectively avoided.

In some embodiments, the STA 110 may be conventional devices with fixed or pre-assigned MAC address. In such a configuration, the STA may implement a preliminary verification with the WLC 125 before the first association, to check the validity of the fixed MAC address within the current ESS 100. Once verified, the STA may continue to use this address for subsequent associations without the need to submit a new proposed MAC address during the 4-way handshake process. However, there is possibility that during the first association, the fixed MAC address is already in use by another device within the ESS. To address this issue, in some embodiments, the WLC 125 may instruct the STA to delay its association attempt and then try again after a specified period of time. In some embodiments, as an alternative to delaying the association, the WLC may allocate a new MAC address to the STA, and establish a translation entry linking the new MAC to the original fixed MAC. This approach ensures continuous service for the STA without the risks associated with waiting for the address to become available. The newly allocated MAC address may then be recorded in the ESS-wide database to update the network's records and prevent future conflicts.

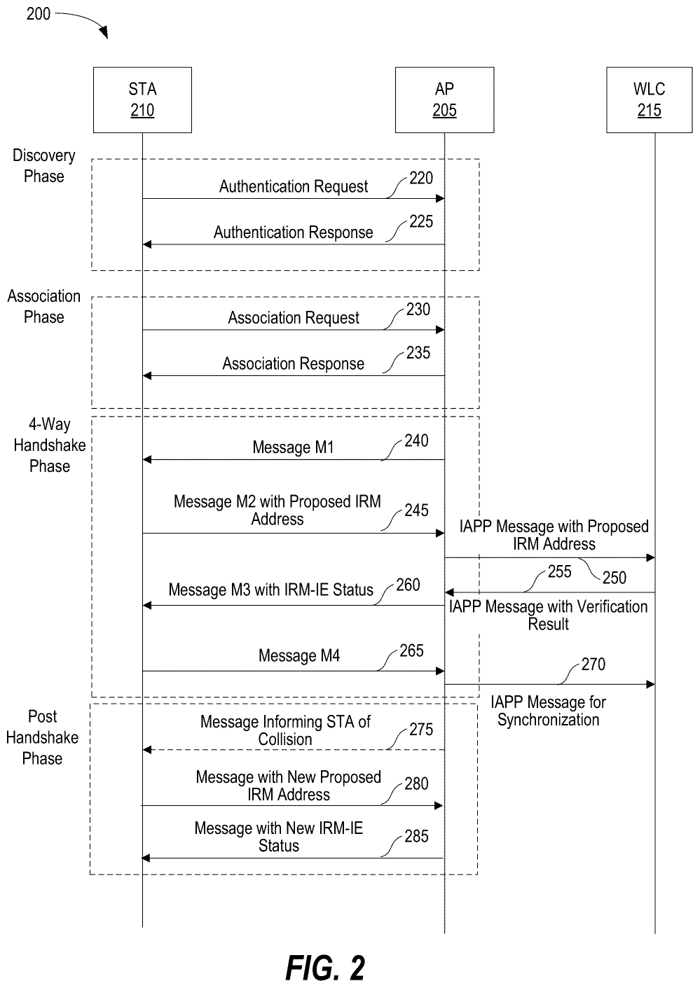

FIG. 2 depicts an example sequence 200 of message exchanges between a STA, AP and WLC to address MAC address collision, according to some embodiments of the present disclosure.

As illustrated, the STA 210 initiates the discovery phase by sending an authentication request to the AP 205 (step 220). In some embodiments, the STA 210 may correspond to the STA 110 as depicted in FIG. 1, and the AP 205 may correspond to the AP 105 as depicted in FIG. 1. The authentication request is used to start the process of establishing a secure connection with the AP 205. In some embodiments, the authentication request may include the current MAC address of the STA 210, which the AP 205 can use to verify the identity of the STA 210.

After receiving the request, the AP 205 verifies the identity of the STA 210, and responds with an authentication response to indicate whether the STA is authorized or rejected (step 225). Once the STA 210 is authorized, it sends an association request to the AP 205 (step 230). Within the request, the STA may indicate its intent to join the BSS and establish a data link. In some embodiments, the association request may include the STA's current MAC address, supported data rates, and other capabilities. The AP 205 analyzes the information, and if it grants the request, an association ID is generated to manage the connection with the STA 210. The AP 205 then includes the association ID and other relevant information within an association response, and sends it back to the STA 210 (step 235).

Following the successful authentication and association, a network connection is established between the AP 205 and STA 210. Subsequently, a WAP2 4-way handshake process is initiated. The primary purpose of the 4-way handshake is to establish a secure encryption key that both the STA 210 and AP 205 will use for protecting data transmissions. In the present disclosure, the next MAC address that the STA intends to use may be included in one of the handshake messages to verify its uniqueness. As illustrated, the AP 205 sends the M1 message to the STA (step 240). In some embodiments, the M1 message may include the AP's nonce (Anonce), which is a random number generated by the AP 205. The STA 210 responds by sending the M2 message to the AP 205 (step 245), which includes the information to generate the pairwise transient key (PTK), such as the STA's nonce (Snonce) and a message integrity code (MIC). Additionally, one of the handshake messages further includes a proposed MAC address (such as an IRM) that the STA intends to use in a future association. In some embodiments, the proposed MAC address may be encapsulated in an IRM-IE.

In one example, after receiving the handshake message including the proposed new IRM from the STA, the AP forwards the proposed MAC address to the WLC 215 for verification (step 250). In some embodiments, the MAC address may be included within an IAPP message and sent to the WLC 215. The WLC 215 checks the ESS-wide database to determine if the proposed IRM address is already in use by another STA within the ESS.

In some embodiments, the ESS-wide database may include information on all active MAC addresses currently in use within the ESS. If the proposed address matches an active MAC address, it indicates that the proposed address is in use, and the WLC marks it as a collision. If there is no match, it indicates the proposed address is not in use, and the WLC marks it as available. In some embodiments, each of the active MAC addresses within the ESS-wide database may be associated with a specific validity time (also referred to in some embodiments as lease time). As used herein, the validity time indicates that the allocation of the address to a specific STA is only valid for that period of time. When the time passes, the MAC address becomes free and can be used by another STA. In such a configuration, the proposed MAC address may be determined as free when there is no match or when the validity time associated with a matching address has expired.

Following the verification, the WLC 215 sends a response back to the AP, indicating the status of the proposed MAC address (e.g., “recognized” or “collision”) (step 255). In some embodiments, the response may be an IAPP message or similar protocol message. The AP 205 then uses this information to proceed with the handshake process.

After receiving the response from the WLC 215, the AP 205 sends the M3 message to the STA 210 (step 260), providing the group key for multicast/broadcast traffic and the verification result of the proposed MAC address. Following that, the STA 210 sends the M4 message to the AP 205 (step 265), confirming the reception of the GTK and the verification status.

As depicted, when no collision occurs, the AP 205 may send a message to the WLC 215 after receiving the M4 message (step 270). In some embodiments, the response may confirm the allocation of the proposed MAC address to the STA 210, and instruct the WLC 215 to update the ESS-wide database accordingly. In some embodiments, the database update may include synchronizing the new allocation across all APs within the ESS to prevent future collision.

If a collision is detected, the process moves to the post-handshake phase to resolve the collision. As illustrated, the AP 205 sends a message to the STA 210, informing the STA of the collision (step 275). The STA 210, in response, sends a new proposed MAC address to the AP 205 for verification (step 280). In some embodiments, the new proposed MAC address may be encapsulated within an IRM-IE and sent in an action frame. After receiving the new proposed address, the AP communicates it with the WLC 215, which checks the ESS-wide database to verify if the new proposed address is already in use, and returns the result to the AP 205. The AP may then forward the status of the new proposed MAC address back to the STA (step 285), indicating whether the new address is recognized or if another collision has occurred. The process of resubmitting a proposed MAC address may be repeated until a unique MAC address is verified and allocated to the STA 210. The iterative process ensures that the next MAC address the STA intends to use is unique within the network, and therefore prevents any potential data transmission conflicts and network management issues.

In some embodiments, instead of or in addition to relying on a central ESS-wide database and forwarding every proposed MAC address to the WLC 215 for verification, an alternative decentralized approach may be adopted. In this configuration, the AP 205 may maintain a local database that includes all actively used MAC addresses or those stored for use within the ESS. During the 4-way handshake process, after receiving a handshake message that includes the proposed MAC address, the AP 205 may check its local database to determine whether the address is currently in use within the network. The AP may include the verification result in a message sent back to the STA 210. After successful verification that a unique MAC address is allocated, the AP may send a synchronization request to the WLC (step 270), requesting the WLC to inform other APs within the ESS of the new MAC address allocation. The synchronization ensures ESS-wide consistency and avoid potential future collisions.

However, in decentralized systems where each AP maintains its own local database of actively used MAC addresses, there may be a delay in synchronizing this information across the network. If STAs in different BSSs independently choose the same address and submit these for verification to their respective APs simultaneously, each AP, relying on its own database, may find the address to be available. As a result, both APs may approve the use of the same MAC address without awareness of the concurrent approval by another AP, leading to an address collision. To address this issue and avoid collision, a conflict resolution mechanism may be implemented. For example, after an AP approves a proposed MAC address, it may receive a synchronization update from the WLC, indicating that another AP within the same ESS has concurrently approved the same address. To resolve this collision, the AP may send a message (like an action frame) to the STA that originally proposed the MAC address. The message may inform the STA of the collision and the status change, which will prompt the STA to resubmit a new MAC address for verification.

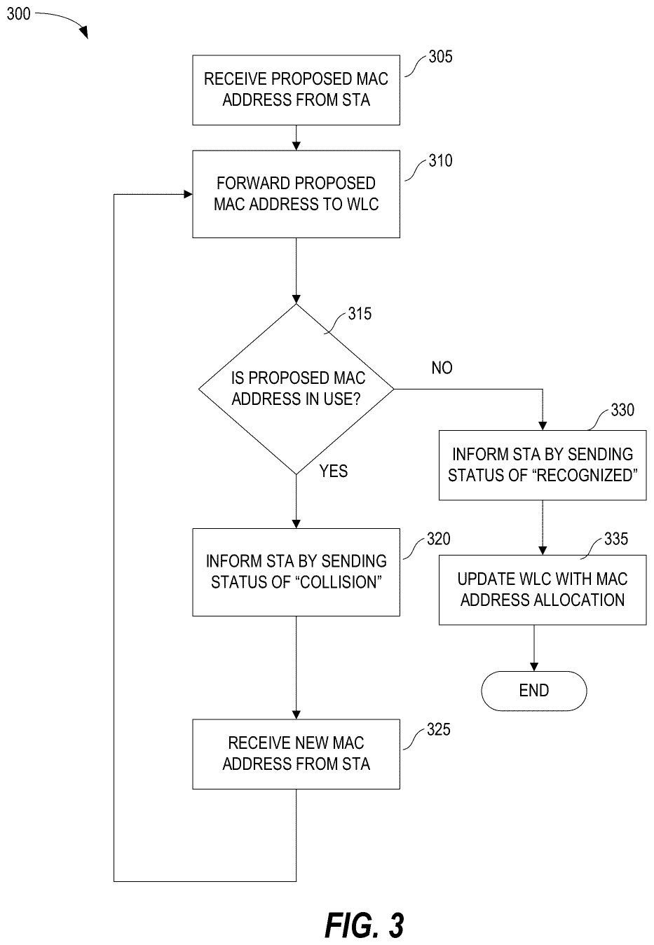

FIG. 3 depicts an example method 300 for an AP verifying the status of a received MAC address and coordinating with a STA to avoid collision, according to some embodiments of the present disclosure. In some embodiments, the method 300 may be performed by one or more APs, such as APs 105, as depicted in FIG. 1, and AP 205, as depicted in FIG. 2. In some embodiments, the method 300 may be performed by one or more other network devices that possess the required capabilities for dynamic network management, such as the WLC 125, router 120, and network switch 115, as depicted in FIG. 1.

The method 300 begins at block 305, where an AP (e.g., 105-1 of FIG. 1) receives a proposed MAC address from its associated STA (e.g., 110-1 of FIG. 1). In some embodiments, the address may be generated following IRM protocols and intended for use in the next association session. In some embodiments, the proposed MAC address may be encapsulated within an IRM-IE and sent in a handshake message during the 4-way handshake process.

At block 310, the AP forwards the proposed MAC address to a WLC (e.g., 125 of FIG. 1), which manages the network to which the AP belongs (e.g., ESS 100 of FIG. 1). In some embodiments, the WLC may connect to a central database that maintains a record of all actively used MAC addresses within the ESS. Upon receiving the address, the WLC may check the database to verify if the address is already in use. In some embodiments, the address may be determined to be in use if it matches an existing record in the database. If there is no match, the address may be considered free (or not in use).

In some embodiments, each actively used address in the database may be linked to a validity time (also referred to in some embodiments as lease time). The validity time refer to the period during which the address is reserved for use by a specific STA. In some embodiments, when the STA sends the MAC address for verification, it may include an additional field within the IRM-IE specifying the requested validity time. Once allocated, the address and its associated validity time may be saved in the database. When the validity time has passed, the address is treated as released and free to be reused by another STA. In such a configuration, the proposed MAC address from the STA may be determined as free when there is no direct match in the database, or when a matching address is identified but its associated validity time has expired.

At block 315, the AP receives the verification results from the WLC. In some embodiments, the communications between the AP and the WLC, such as AP forwarding the proposed MAC address or the WLC sharing the verification results, may use the IAPP or other suitable protocol to ensure secure and reliable data transfer.

If the result indicates that the proposed address is free to use (no collision is detected or the validity time of a matching address has expired), the method 300 proceeds to block 330, where the AP informs the STA of the positive outcome. In some embodiments, the information may be communicated to the STA during the 4-way handshake, indicating the status of “recognized” for the proposed MAC address. Following the confirmation, at block 335, the AP notifies the WLC of the new allocation, requesting the WLC to update the central database to ensure all APs within the ESS informed of the new MAC address.

If the result indicates that the proposed address is already in use (there is a collision detected and the validity time of the matching address has not expired), the method 300 moves to block 320, where the AP informs the STA by sending a status of “collision” in a message to the STA. At block 325, after the handshake process, the AP receives the new proposed address from the STA for reverification. The method 300 returns to block 310, where the AP forwards the new address to the WLC for another round of verification. This loop may continue until a unique MAC address is allocated to the STA, allowing the STA to continue operating within the ESS without causing a MAC address collision.

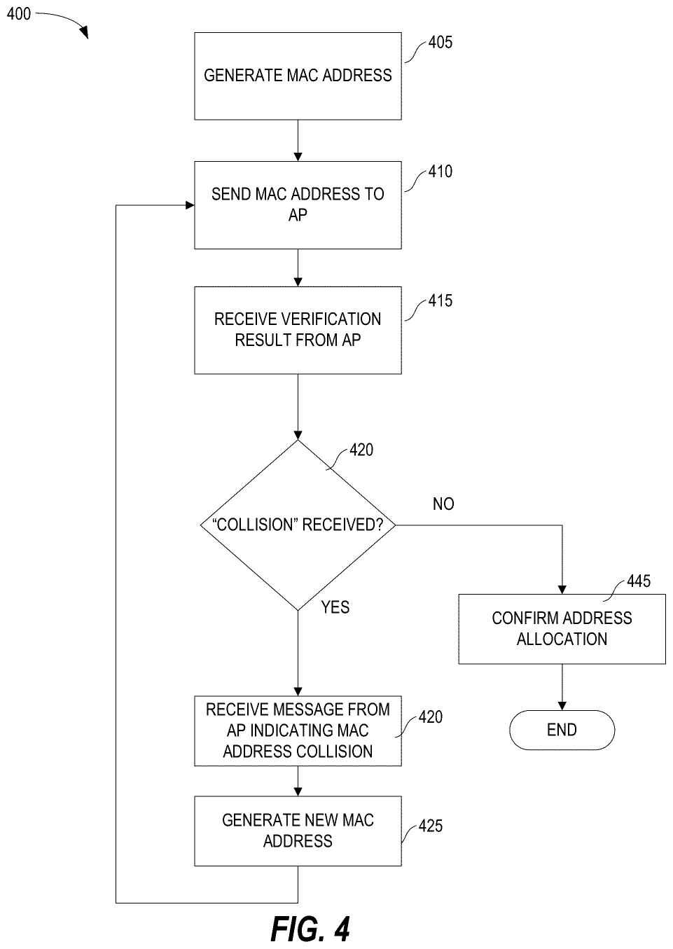

FIG. 4 depicts an example method 400 for a STA proposing a MAC address and submitting the address to its connected AP for verification, according to some embodiments of the present disclosure. In some embodiments, the method 400 may be performed by one or more STAs, such as STAs 110, as depicted in FIG. 1, and STA 210, as depicted in FIG. 2.

At block 405, an STA (e.g., 110-1 of FIG. 1) generates a MAC address that it intends to use in the next association process. In some embodiments, the address may be generated using IRM protocols, which involves creating a MAC address by combining predefined parts of a MAC address format with values that are randomly generated. Such operation enables the device's hardware-based (permanent) MAC address to be concealed from view in the generated MAC address, therefore improving the network's privacy and security.

At block 410, the STA sends the generated MAC address to its currently associated AP (e.g., 105-1 of FIG. 1). In some embodiments, the address may be encapsulated within an IRM-IE, and sent in one of the handshake messages sent to the AP during the 4-way handshake process. After receiving the MAC address, the AP may communicate with a WLC (e.g., 125 of FIG. 1) to check an ESS-wide database, and verify whether the proposed MAC address is already in use within the ESS.

At block 415, the STA receives the verification result from the AP regarding the submitted MAC address. If the address is in use, the result may include a status of “collision,” indicating that the MAC address has already been assigned to another device within the network. If the address is not in use, the result may include a status of “recognized,” indicating that the MAC has been acknowledged and allocated to the STA.

At block 420, the STA processes the verification result to determine the next steps. If the status of “collision” is received, the method 400 proceeds to block 420, where the STA receives a message from the AP indicating a collision for the MAC address. At block 425, the STA generates a new MAC address using IRM protocols. The method 400 then returns to block 420, where the new MAC address is sent to the associated AP for another round of verification after the handshake process is completed. The process may be repeated until a unique MAC address is generated and allocated to the STA.

If the status of “recognized” is received, the method 400 moves to block 445, where the STA sends an acknowledgement to the AP, confirming the successful reception and acceptance of the MAC address allocation. In some embodiments, the STA may include the acknowledgement in the M4 message sent to the AP.

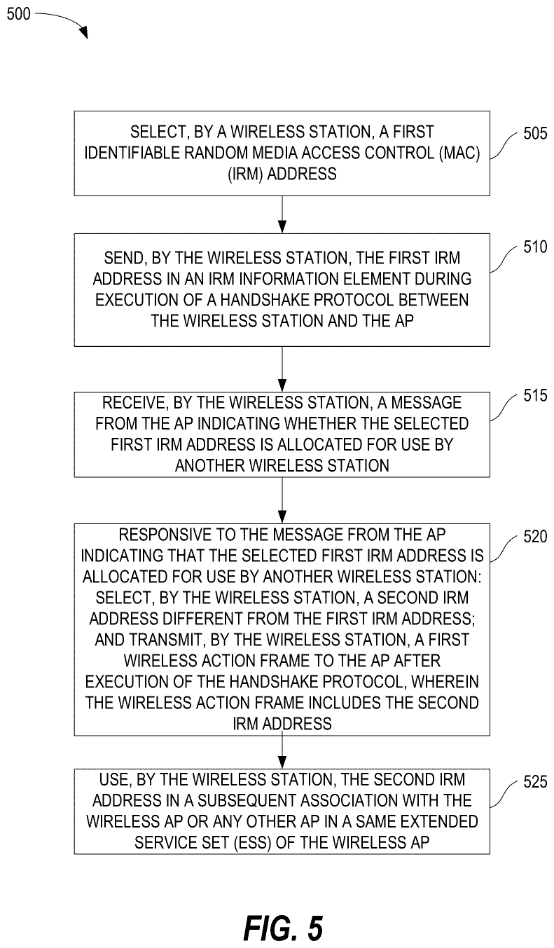

FIG. 5 is a flow diagram depicting an example method 500 for MAC address coordination, according to some embodiments of the present disclosure.

At block 505, a wireless station (e.g., 110-1 of FIG. 1) selects a first Identifiable Random Media Access Control (MAC) (IRM) address.

At block 510, the wireless station sends the IRM address in an IRM information element during execution of a handshake protocol between the wireless station and the AP (e.g., 105-1 of FIG. 1).

At block 515, the wireless station receives a message from the AP indicating whether the selected first IRM address is allocated for use by another wireless station.

At block 520, responsive to the message from the AP indicating that the selected first IRM address is allocated for use by another wireless station, the wireless station selects a second IRM address different from the first IRM address, and transmits a first wireless action frame to the AP after execution of the handshake protocol, where the wireless action frame includes the second IRM address.

At block 525, the wireless station uses the second IRM address in a subsequent association with the wireless AP or any other AP in a same extended service set (ESS) of the wireless AP.

In some embodiments, the wireless station may further receive a second wireless action frame from the AP, where the second wireless action frame indicates a recognition or a collision of the second IRM address.

In some embodiments, when the second wireless action frame indicates recognition of the second IRM address, the second wireless action frame may further comprise an indication of a validity time period for the second IRM address.

In some embodiments, the handshake protocol may be an authentication protocol.

In some embodiments, the AP (e.g., 105-1 of FIG. 1) may send the second IRM address to the any other AP (e.g., 105-2 or 105-3 of FIG. 1) in the same ESS (e.g., 100 of FIG. 1).

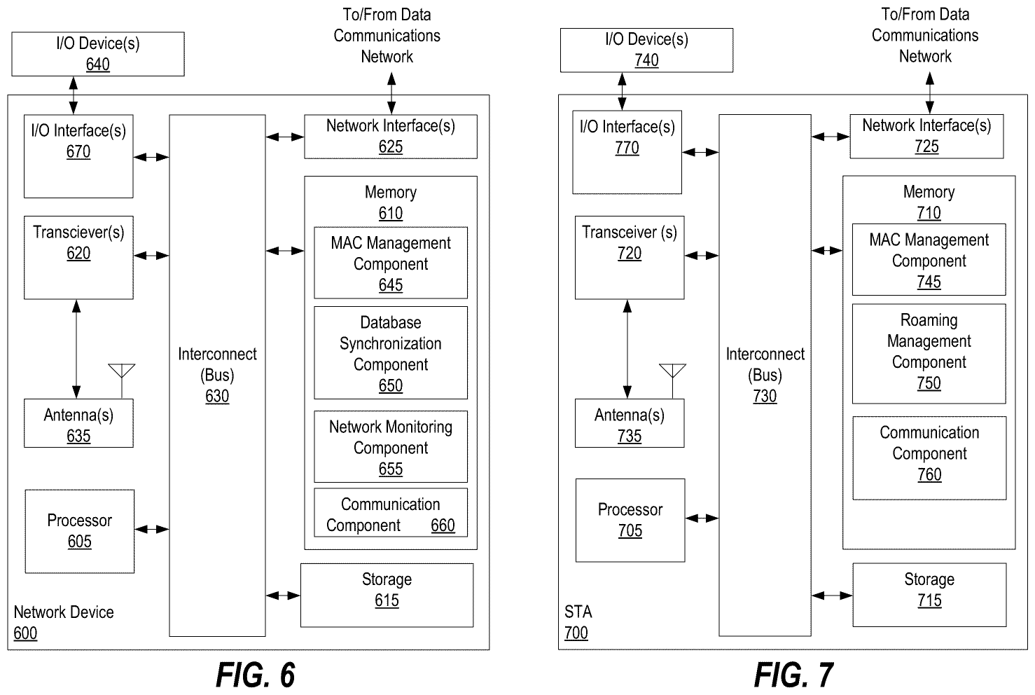

FIG. 6 depicts an example network device 600 supporting MAC address coordination, according to some embodiments of the present disclosure. In some embodiments, the example network device 600 may correspond to the APs 105, as depicted in FIG. 1, or the AP 205, as depicted in FIG. 2. In some embodiments, the example network device 600 may correspond to the WLC 125, as depicted in FIG. 1, or the WLC 215, as depicted in FIG. 2.

As illustrated, the example network device 600 includes a processor 605, memory 610, storage 615, one or more transceivers 620, one or more I/O interfaces 670, and one or more network interfaces 625. In some embodiments, I/O devices 640 are connected via the I/O interface(s) 670. Further, via the network interface 625, the network device 600 can be communicatively coupled with one or more other devices and components (e.g., via a network, which may include the Internet, local network(s), and the like). Each of the components is communicatively coupled by one or more buses 630. In some embodiments, one or more antennas 635 may be coupled to the transceivers 620 for transmitting and receiving wireless signals.

The processor 605 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 605 processes information received through the transceiver 620, I/O interfaces 670, and the network interfaces 625. The processor 605 retrieves and executes programming instructions stored in memory 610, as well as stores and retrieves application data residing in storage 615.

The storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 615 may store a variety of data for the efficient functioning of the system.

The memory 610 may include random access memory (RAM) and read-only memory (ROM). The memory 610 may store processor-executable software code containing instructions that, when executed by the processor 605, enable the network device 600 to perform various functions described herein for wireless communication. In the illustrated example, the memory 610 includes three software components: the MAC management component 645, the database synchronization component 650, the network monitoring component 655, and the communication component 660. The MAC management component 645 is configured to handle the reception, verification, and allocation of the proposed MAC addresses from STAs. For example, in some embodiments, the MAC management component 645 may receive a proposed MAC address from an associated STA, and communicate the address with a WLC (that controls the current ESS) to verify if the address is free from conflicts. Upon determining the address is free, the MAC management component 645 may reserve the address, confirm its allocation to the STA, and update any necessary records to reflect the new allocation. The database synchronization component 650 is configured to maintain a record of currently used MAC addresses within the network device. When the network device 600 is a WLC, the database synchronization component 650 may update and maintain an ESS-wide database, to ensure data consistency across the ESS. The network monitoring component 655 monitors the status and performance of the network device 600, such as by analyzing traffic patterns and usage to optimize performance, and respond to potential security threats or operational inefficiency. The communication component 660 is designed to facilitate communication between the network device 600 and other entities within the network. In some embodiments, the communication component 660 may handle protocol-specific communications (like IAPP) to ensure reliable and secure data transmission across the network.

Although depicted as a discrete component for conceptual clarity, in some embodiments, the operations of the depicted components (and others not illustrated) may be combined or distributed across any number of components. Further, although depicted as software residing in memory 610, in some aspects, the operations of the depicted components (and others not illustrated) may be implemented using hardware, software, or a combination of hardware and software.

FIG. 7 depicts an example client device 700 supporting MAC address coordination, according to some embodiments of the present disclosure. In some embodiments, the example client device 700 may correspond to the STAs 110 as depicted in FIG. 1, or the STA 210 as depicted in FIG. 2.

As illustrated, the example client device 700 includes a processor 705, memory 710, storage 715, one or more transceivers 720, one or more I/O interfaces 770, and one or more network interfaces 725. In some embodiments, I/O devices 740 are connected via the I/O interface(s) 770. Further, via the network interface 725, the client device 700 can be communicatively coupled with one or more other devices and components (e.g., via a network, which may include the Internet, local network(s), and the like). Each of the components is communicatively coupled by one or more buses 730. In some embodiments, one or more antennas 735 may be coupled to the transceivers 720 for transmitting and receiving wireless signals.

The processor 705 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 705 processes information received through the transceiver 720, I/O interfaces 770, and the network interfaces 725. The processor 705 retrieves and executes programming instructions stored in memory 710, as well as stores and retrieves application data residing in storage 715.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 715 may store a variety of data for the efficient functioning of the system.

The memory 710 may include random access memory (RAM) and read-only memory (ROM). The memory 710 may store processor-executable software code containing instructions that, when executed by the processor 705, enable the client device 700 to perform various functions described herein for wireless communication. In the illustrated example, the memory 710 includes three software components: the MAC management component 745, the roaming management component 750, and the communication component 760. The MAC management component 745 is configured to generate a MAC address (e.g., following the IRM protocols), and send it to the associated AP for verification. The generated MAC address is intended for use in the next association session. Once receiving the verification results from the AP, the MAC management component 745 analyzes the data and takes appropriate actions. For example, if a collision is detected, the component 745 may generate a new MAC address and resubmit it to the AP. If no collision is detected, the component 745 may send an acknowledgement to the associated AP, confirming the allocation of the MAC address. The roaming management component 750 manages the device's roaming processes to maintain continuous network connectivity when moving across different APs within the same ESS. The roaming management component 750 works closely with the MAC management component 745 to ensure the roaming process uses a MAC address that is valid and recognized across the network. The communication component 760 is configured to handle data transmission between the client device 700 and other entities within the network, such as APs, routers, and switches. For example, in some embodiments, during the 4-way handshake process, the communication component 760 may include the generated MAC address within the M2 message, and extract the results of the MAC address verification from the M3 message received from the AP. In some embodiments, after the completion of the 4-way handshake process, the communication component 760 may send a new MAC address using an action frame.

Although depicted as a discrete component for conceptual clarity, in some embodiments, the operations of the depicted components (and others not illustrated) may be combined or distributed across any number of components. Further, although depicted as software residing in memory 710, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

### Example Clauses

Implementation examples are described in the following numbered clauses:

Clause 1: A method, comprising: establishing, by an access point (AP) within an extended service set (ESS), a network connection with a client device using a first media access control (MAC) address; receiving, by the AP, a second MAC address from the client device, wherein the second MAC address comprises an address the client device intends to use during a next association process; verifying whether the second MAC address is in use within the ESS by checking a database; upon determining that the second MAC address is not in use within the ESS, allocating, by the AP, the second MAC address to the client device; and updating, by the AP, the database based on the allocation of the second MAC address.

Clause 2: The method of Clause 1, further comprising: receiving, by the AP, a third MAC address from the client device, wherein the third MAC address comprises an address the client device intends to use during the next association process; and upon determining that the third MAC address is in use within the ESS, sending, by the AP, a collision notification to the client device.

Clause 3: The method of Clause 2, further comprising: sending, by the AP, a message to the client device requesting a new MAC address; receiving, by the AP, a fourth MAC address from the client device; and verifying, by the AP, whether the fourth MAC address is in use within the ESS.

Clause 4: The method of Clause 1, wherein the second MAC address is encapsulated in an identifiable random MAC information element (IRM-IE), and received during a 4-way handshake process with the client device.

Clause 5: The method of Clause 1, wherein updating the database based on the allocation of the second MAC address comprises sending a notification to a wireless LAN controller (WLC) within the ESS, indicating the allocation of the second MAC address, wherein the WLC, upon receiving the notification, synchronizes the database across other APs within the ESS.

Clause 6: The method of Clause 1, wherein: the database comprises a plurality of allocated MAC addresses within the ESS, and each respective allocated MAC address, of the plurality of allocated MAC addresses, is associated with a respective validity time.

Clause 7: The method of Clause 6, wherein determining that the second MAC address is not in use within the ESS comprises determining a validity time associated with the second MAC address has expired.

Clause 8: An access point (AP) within an extended service set (ESS), comprising: one or more computer processors; and one or more memories collectively containing one or more programs, which, when executed by the one or more computer processors, perform operations in accordance with any one of Clauses 1-7.

Clause 9: One or more non-transitory computer-readable media containing, in any combination, computer program code, which, when executed by a computer system, performs operations in accordance with any one of Clauses 1-7.

We claim:

1. A method in a wireless network comprising at least one wireless station and at least one access point (AP):
receiving, by a wireless access point (AP), a first Identifiable Random Media Access Control (MAC) (IRM) address in an IRM information element during execution of a handshake protocol between the AP and a wireless station, wherein the first IRM address is selected by the wireless station;
determining that the first IRM address is allocated for use by another wireless station;
transmitting, by the wireless AP, a message to the wireless station indicating that the first IRM address is allocated for use by another wireless station;
receiving, by the wireless AP, a first wireless action frame transmitted by the wireless station after execution of the handshake protocol, wherein the wireless action frame includes a second IRM address selected by the wireless station in response to the message from the AP indicating that the first IRM address is allocated for use by another wireless station; and
establishing a wireless connection with the wireless station in a subsequent association with the wireless station, wherein the wireless station uses the second IRM address in the subsequent association.

2. The method of claim 1 further comprising
transmitting, by the wireless AP, a second wireless action frame to the wireless station, wherein the second wireless action frame indicates a recognition or a collision of the second IRM address.

3. The method of claim 2 wherein, when the second wireless action frame indicates recognition of the second IRM address, the second wireless action frame further comprises an indication of a validity time period for the second IRM address.

4. The method of claim 1 wherein the handshake protocol is an authentication protocol.

5. The method of claim 1 further comprising transmitting a notification of an allocation of the second IRM address to one or more other access points in an Extended Service Set (ESS).

6. A wireless access point comprising
at least one memory element for storing data; and
at least one processor for executing instructions associated with the data, wherein executing the instructions causes the wireless access point to perform operations, the operations comprising:
receiving, by a wireless access point (AP), a first Identifiable Random Media Access Control (MAC) (IRM) address in an IRM information element during execution of a handshake protocol between the AP and a wireless station, wherein the first IRM address is selected by the wireless station;
determining that the first IRM address is allocated for use by another wireless station;
transmitting, by the wireless AP, a message to the wireless station indicating that the first IRM address is allocated for use by another wireless station;
receiving, by the wireless AP, a first wireless action frame transmitted by the wireless station after execution of the handshake protocol, wherein the wireless action frame includes a second IRM address selected by the wireless station in response to the message from the AP indicating that the first IRM address is allocated for use by another wireless station; and
establishing a wireless connection with the wireless station in a subsequent association with the wireless station, wherein the wireless station uses the second IRM address in the subsequent association.

7. The wireless access point of claim 6 wherein the operations further comprise:
transmitting, by the wireless AP, a second wireless action frame to the wireless station, wherein the second wireless action frame indicates a recognition or a collision of the second IRM address.

8. The wireless access point of claim 7 wherein, when the second wireless action frame indicates recognition of the second IRM address, the second wireless action frame further comprises an indication of a validity time period for the second IRM address.

9. The wireless access point of claim 6 wherein the handshake protocol is an authentication protocol.

10. The wireless access point of claim 6 wherein the operations further comprise: transmitting a notification of an allocation of the second IRM address to one or more other access points in an Extended Service Set (ESS).

11. A non-transitory computer-readable storage medium having stored therein instructions which, when executed by a processor, cause the processor to perform operations, the operations comprising:
receiving, by a wireless access point (AP), a first Identifiable Random Media Access Control (MAC) (IRM) address in an IRM information element during execution of a handshake protocol between the AP and a wireless station, wherein the first IRM address is selected by the wireless station;
determining that the first IRM address is allocated for use by another wireless station;
transmitting, by the wireless AP, a message to the wireless station indicating that the first IRM address is allocated for use by another wireless station;
receiving, by the wireless AP, a first wireless action frame transmitted by the wireless station after execution of the handshake protocol, wherein the wireless action frame includes a second IRM address selected by the wireless station in response to the message from the AP indicating that the first IRM address is allocated for use by another wireless station; and
establishing a wireless connection with the wireless station in a subsequent association with the wireless station, wherein the wireless station uses the second IRM address in the subsequent association.

12. The computer-readable storage medium of claim 11 wherein the operations further comprise:
transmitting, by the wireless AP, a second wireless action frame to the wireless station, wherein the second wireless action frame indicates a recognition or a collision of the second IRM address.

13. The computer-readable storage medium of claim 12 wherein, when the second wireless action frame indicates recognition of the second IRM address, the second wireless action frame further comprises an indication of a validity time period for the second IRM address.

14. The computer-readable storage medium of claim 11 wherein the handshake protocol is an authentication protocol.

15. The computer-readable storage medium of claim 11 wherein the operations further comprise:
transmitting a notification of an allocation of the second IRM address to one or more other access points in an Extended Service Set (ESS).
